(19) United States
(12) Patent Application Publication
(10) Pub. No.: US 2025/0264146 A1
(43) Pub. Date: Aug. 21, 2025

(54) ELECTRIC AIR PRESSURE ROD

(71) Applicant: Changzhou Weien Technology Development Co., Ltd, Changzhou (CN)

(72) Inventors: Zhiwen TAO, Changzhou (CN); Xiaogang LI, Changzhou (CN)

(73) Assignee: Changzhou Weien Technology Development Co., Ltd, Changzhou (CN)

(21) Appl. No.: 19/006,292

(22) Filed: Dec. 31, 2024

(30) Foreign Application Priority Data
Feb. 20, 2024 (CN) 202420308407.X

(51) Int. Cl. F16F 9/46

(52) U.S. Cl. CPC F16F 9/463; F16F 9/462

(57) ABSTRACT

An electric air pressure rod includes lifting rod, gas spring, nut and driving unit. Lifting rod includes outer tube of lifting rod and inner tube of lifting rod, wherein outer tube of lifting rod can move along the axial direction of the inner tube of the lifting rod. Gas spring is arranged inside lifting rod and is included of thread tube with thread on outer wall, piston as well as piston rod, wherein distance between piston rod as well as inner tube of lifting rod remains constant, wherein piston is located at free end of piston rod and in the sliding seat with inner wall of thread tube, wherein seal guide assembly is provided between piston rod and thread tube. Nut is adapted to the thread tube. Driving unit is fixedly arranged in outer tube of the lifting rod and serves to drive the thread tube in rotation.

### CROSS-REFERENCE TO THE RELATED APPLICATIONS

This application is based upon and claims priority to Chinese Patent Application No. 202420308407.X, filed on Feb. 20, 2024, the entire contents of which are incorporated herein by reference.

### TECHNICAL FIELD

The present invention relates to the technical field of air pressure rod, especially to electric air pressure rod.

### BACKGROUND

The lifting chair is a new type of chair which mainly consists of the seat plate, the backrest, the lifting device and the chair legs. It can meet the needs of different people regarding seat height. Existing lifting devices possess usually electric structure, pneumatic structure or manual structure. The lifting devices with manual structure are often laborious to operate and aesthetic performance is poor, which makes it difficult to meet people's increasing life requirements. The lifting devices with pneumatic structure are in general gas springs with a self-locking structure. This structure is beautiful, and the lifting process is relatively smooth. However, the lifting process requires manual operation, and this chair cannot bear too heavy load when climbing up manually. For example, in traditional lifting chairs, people must leave seat cushion on the chair before they can get up. When descending, they must sit on the chair to exert some load on seat cushion before descending, which makes the chair inconvenient to use. The lifting device with electric structure consists of the motor, the screw rod, the nut of the screw rod and the casing tube in general. The device drives the screw rod by motor to ascent and descent in rotation. The entire lifting process is driven by motor, which ensures automatic ascent and descent are achieved. However, if the weight of the load from seat plates is greater, the engine power must also be increased accordingly. Volume and noise from the high-performance engine during operation increases, which negatively affects the user experience.

### SUMMARY

To solve problems existing in prior art, the present invention proposes electric air pressure rod.

To achieve above-mentioned purpose, the present invention adopts the following technical solutions:

The electric air pressure rod, comprising
lifting rod, which comprises outer tube of lifting rod and inner tube of lifting rod, wherein outer tube of lifting rod can move along the axial direction of inner tube of lifting rod,
gas spring, which is arranged inside lifting rod and is comprised of thread tube with thread on outer wall, piston and piston rod, wherein the distance between piston rod as well as inner tube of lifting rod remains constant, wherein piston is located at free end of piston rod and in the sliding seat with the inner wall of thread tube, wherein seal guide assembly is provided between the piston rod and the thread tube,
nut, which is adapted to thread tube and is located at the end of inner tube of lifting rod,
driving unit, which is fixedly arranged in the outer tube of the lifting rod and serves to drive thread tube in rotation so that the thread tube drives outer tube of the lifting rod to move along the axial direction of inner tube of lifting rod, and
casing tube, which is sleeved on the outer side of the lifting rod, wherein first guide sleeve is arranged between the casing tube and the outer tube of the lifting rod.

Preferably, there is no self-locking between the nut and the thread tube.

Preferably, the outer wall of inner tube of lifting rod is provided with first convex strips evenly distributed along its axis, wherein inner wall of inner tube of lifting rod is provided with first grooves evenly distributed along its axis, wherein second convex strip is provided on the outer wall of the nut, which is adapted to the first groove, wherein
second guide sleeve is provided between outer tube of the lifting rod and inner tube of the lifting rod, wherein the second guide sleeve is firmly connected to the outer tube of the lifting rod, and wherein the second groove is provided on the inner wall of the second guide sleeve, which is adapted to the second convex strip.

Preferably, the driving unit comprises motor, gear box and controller, wherein output end of motor drives thread tube for rotation through gear box.

Preferably, the end of inner tube of lifting rod is connected to the inner tube plug of lifting rod which is connected to the end of piston rod, wherein the side wall of inner tube plug of lifting rod is firmly connected to inner wall of inner tube of lifting rod.

Preferably, third convex strip is provided on the side wall of inner tube plug of lifting rod, which is adapted to first groove.

Preferably, end of casing tube is firmly provided with sealing plate, wherein end of inner tube plug of lifting rod penetrates sealing plate and is connected to sealing plate through a retaining spring.

Preferably, the seal guide assembly comprises spacer sleeve, oil seal and rear upper sleeve, wherein oil seal is located between spacer sleeve and rear upper sleeve, and wherein the rear upper sleeve is fixedly connected to the end of thread tube.

Preferably, connecting end of casing tube and connecting end of outer tube of lifting rod both have the shape of truncated cone.

The beneficial effects of the present invention are as follows:
1. In the present electric air pressure rod, motor drives thread tube in the rotation to make outer tube of lifting rod move along the axial direction of inner tube of lifting rod, thereby making rise or fall of the pressure rod possible. The thread tube itself forms gas spring with piston rod and piston, so that the gas spring has a certain output force when the electric air pressure rod is extended. It can reduce load on motor and increase thrust under same conditions as well. The motor power of the present device is lower than that of motor in traditional electric pushing rod, and battery can be used for power supply, which increases application range of electric air pressure rod. The motor is installed in outer tube of the lifting rod, making the entire electric air pressure rod compact, easy to install and beautiful in structure.
2. In the present electric air pressure rod, thread tube, piston rod and piston form non-self-locking gas spring. By controlling the rotation of the motor, rotation of thread tube can be limited, automatic locking and unlocking of gas spring can be realized and stability of electric air pressure rod can be improved.

### BRIEF DESCRIPTION OF THE DRAWINGS

FIG. 1 shows a schematic diagram of three-dimensional structure related to electric air pressure rod of the present invention.

FIG. 2 shows a schematic diagram of the front view of the structure related to electric air pressure rod of the present invention.

FIG. 3 shows a schematic cross-sectional view related to A-A section of FIG. 2 of electric air pressure rod of the present invention.

FIG. 4 shows a schematic diagram of the three-dimensional structure related to inner tube of the lifting rod of the electric air pressure rod of the present invention.

FIG. 5 shows a schematic diagram of the three-dimensional structure related to the nut of electric air pressure rod of the present invention.

FIG. 6 shows a schematic diagram of the three-dimensional structure related to inner tube plug of lifting rod of electric air pressure rod of the present invention.

FIG. 7 shows a schematic diagram of three-dimensional structure related to second guide sleeve of electric air pressure rod of the present invention.

Among them: 1. Outer tube of lifting rod; 2. Casing tube; 3. Inner tube of lifting rod; 4. Motor; 5. Gear box; 6. Double-ear back plug; 7. Thread tube; 8. Piston rod; 9. Piston; 10. Nut; 11. Spacer sleeve; 12. Oil seal; 13. Rear upper sleeve; 14. Inner tube plug of lifting rod; 15. Plugged cover of tube plug; 16. Bearing; 17. Retaining spring; 18. Upper sleeve of outer tube of lifting rod; 19. First guide sleeve; 20. Second guide sleeve; 31. First convex strip; 32. First groove; 101. Second convex strip; 141. Third convex strip; 201. Second groove.

### DETAILED DESCRIPTION OF THE EMBODIMENTS

The technical solution in embodiments of present invention will be clearly and completely described below in combination with the attached drawings in embodiment of present invention. Obviously, the embodiments described are only part of the embodiments of the present invention, not all embodiments.

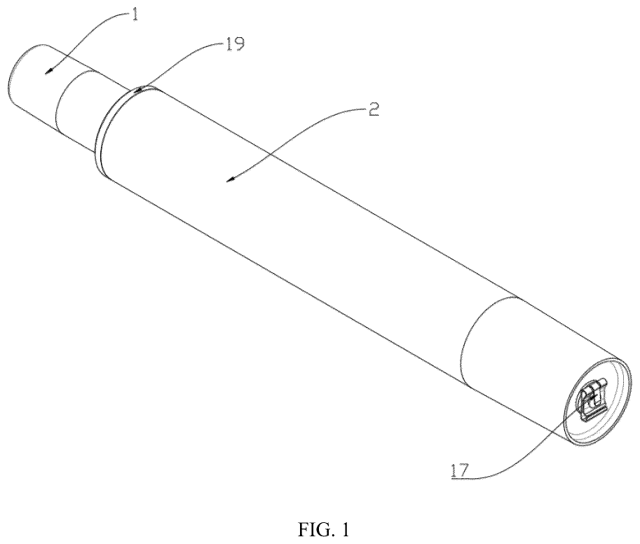

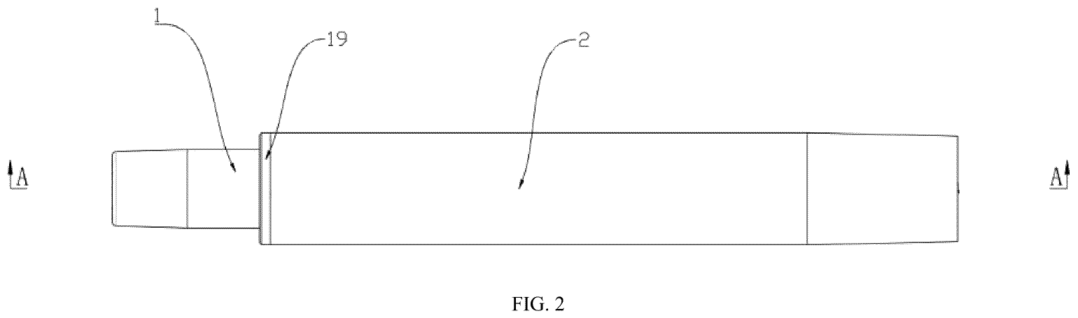

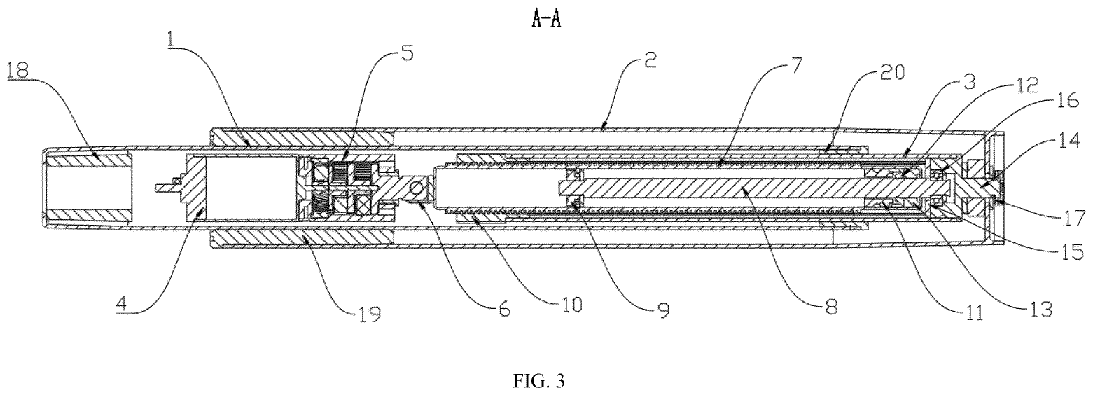

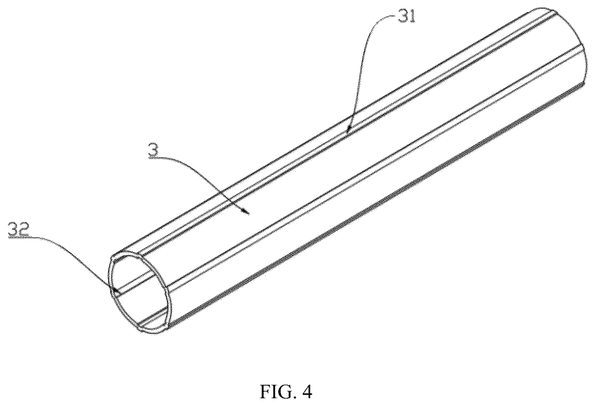

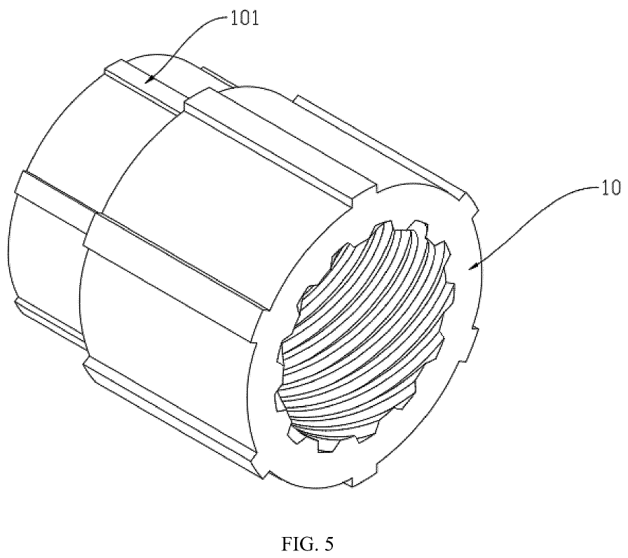

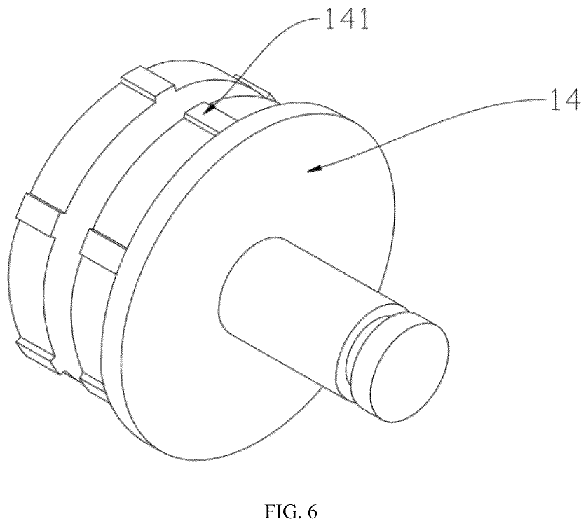

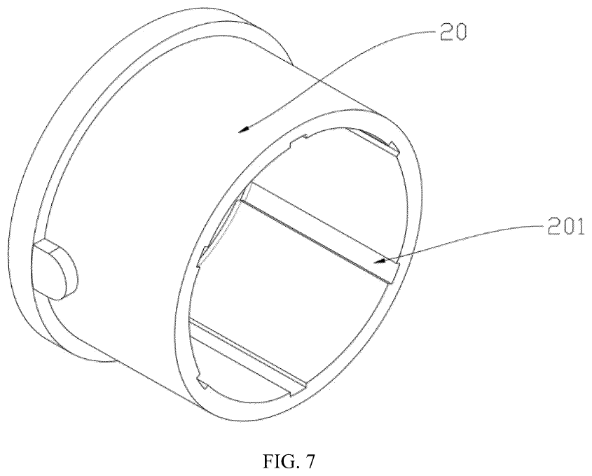

Referring to FIGS. 1 to 7, the electric air pressure rod comprises:
lifting rod, which comprises outer tube of lifting rod 1 as well as inner tube of lifting rod 3, wherein outer tube of the lifting rod 1 can move along the axial direction of inner tube of lifting rod 3,
gas spring, which is arranged inside lifting rod and is comprised of thread tube 7 with the thread on outer wall, piston 9 and the piston rod 8, wherein distance between piston rod 8 as well as inner tube of lifting rod 3 remains constant, wherein piston 9 is located at free end of piston rod 8 and in the sliding seat with inner wall of thread tube 7, wherein seal guide assembly is provided between the piston rod 8 and the thread tube 7,
nut 10, which is adapted to thread tube 7 and is located at the end of inner tube of lifting rod 3,
driving unit, which is fixedly arranged in the outer tube of the lifting rod 1 and serves to drive the thread tube 7 in rotation so that the thread tube 7 drives outer tube of the lifting rod 1 to move along the axial direction of the inner tube of the lifting rod 3, and
casing tube 2, which is sleeved on outer side of the lifting rod, wherein first guide sleeve 19 is arranged between the casing tube 2 and the outer tube of the lifting rod 1.

There is no self-locking between nut 10 and thread tube 7.

Outer wall of inner tube of the lifting rod 3 is provided with first convex strips 31 evenly distributed along its axis, wherein inner wall of inner tube of the lifting rod 3 is provided with first grooves 32 evenly distributed along its axis, wherein second convex strip 101 is provided on outer wall of nut 10, which is adapted to first groove 32, wherein
second guide sleeve 20 is provided between outer tube of lifting rod 1 and inner tube of lifting rod 3, wherein second guide sleeve 20 is firmly connected to outer tube of the lifting rod 1, and wherein second groove 201 is provided on the inner wall of second guide sleeve 20, which is adapted to second convex strip 201.

Driving unit comprises motor 4, gear box 5 and controller, wherein output end of motor 4 drives thread tube 7 for rotation through gear box 5. The controller is Hall encoder or other signal feedback unit. The end of the thread tube 7 can be mounted with double-ear back plug 6, which is connected to output shaft of gear box 5 by pin shaft. The output end of gear box 5 can be connected to the end of thread tube 7 via coupling.

End of inner tube of lifting rod 3 is provided with inner tube plug of lifting rod 14, which is connected to the end of piston rod 8, wherein the side wall of inner tube plug of lifting rod 14 is firmly connected to the inner wall of inner tube of lifting rod 3. Between inner tube plug of lifting rod and piston rod 8, bearing 16 is installed. Plugged cover of tube plug 15 for axially limiting the bearing is also fixedly mounted on inner tube plug of lifting rod 14.

Third convex strip 141 is provided on the side wall of inner tube plug of the lifting rod 14, which is adapted to first groove 32.

Top end of outer tube of lifting rod 1 is fixedly installed with upper sleeve of outer tube of lifting rod 18.

The sealing plate is fixedly provided at the end of casing tube 2, and the end of inner tube plug of the lifting rod 14 penetrates through sealing plate and is connected to sealing plate through retaining spring 17.

The seal guide assembly comprises spacer sleeve 11, oil seal 12 and rear upper sleeve 13, wherein oil seal 12 is located between spacer sleeve 11 and rear upper sleeve 13, and wherein the rear upper sleeve 13 is fixedly connected to the end of thread tube 7.

Connecting end of casing tube 2 and connecting end of outer tube of the lifting rod 1 both have the shape of truncated cone. That is, ends of casing tube 2 as well as outer tube of lifting rod 1 are set at an angle, which is the same as current connection method of conventional gas pressure rod with the taper fit.

In the present electric air pressure rod, motor 4 drives thread tube 7 in the rotation to make outer tube of lifting rod 1 move along axial direction of inner tube of lifting rod 3, thereby making rise or fall of the pressure rod possible. The thread tube 7 itself forms gas spring with piston rod 8 and piston 9, so that gas spring has a certain output force when electric air pressure rod is extended. It can reduce the load on motor 4 and increase thrust under the identical conditions as well. Motor power of present device is lower than that of motor 4 in traditional electric pushing rod, and battery can be used for power supply, which increases application range of electric air pressure rod. Motor 4 is installed in outer tube of lifting rod 1, making entire electric air pressure rod compact, easy to install and beautiful in structure.

In the present electric air pressure rod, thread tube 7, piston rod 8 and piston 9 form non-self-locking gas spring. By controlling the rotation of the motor 4, rotation of thread tube 7 can be limited, automatic locking and unlocking of gas spring can be realized and stability of electric air pressure rod can be improved.

The above content is only a preferred embodiment of the present invention. For ordinary technicians in the art, the changes are obtained based on the exemplary embodiment and applying scope according to the idea of the present invention, the content of the specification should not be understood as a limitation of the present invention. Any modifications, improvements, equivalent replacements and the like, made within the spirit as well as principle of the present invention, shall all be included in the protection scope of the present invention.

What is claimed is:

1. An electric air pressure rod, comprising
a lifting rod, wherein the lifting rod comprises an outer tube of the lifting rod and an inner tube of the lifting rod, wherein the outer tube of the lifting rod is allowed to move along an axial direction of the inner tube of the lifting rod,
a gas spring, wherein the gas spring is arranged inside the lifting rod and is comprised of a thread tube with a thread on an outer wall of the thread tube, a piston and a piston rod, wherein a distance between the piston rod as well as the inner tube of the lifting rod remains constant, wherein the piston is located at a free end of the piston rod and in a sliding seat with an inner wall of the thread tube, wherein a seal guide assembly is provided between the piston rod and the thread tube,
a nut, wherein the nut is adapted to the thread tube and is located at an end of the inner tube of the lifting rod,
a driving unit, wherein the driving unit is fixedly arranged in the outer tube of the lifting rod and serves to drive the thread tube in rotation, wherein the thread tube drives the outer tube of the lifting rod to move along the axial direction of the inner tube of the lifting rod, and
a casing tube, wherein the casing tube is sleeved on an outer side of the lifting rod, wherein a first guide sleeve is arranged between the casing tube and the outer tube of the lifting rod.

2. The electric air pressure rod according to claim 1, wherein there is no self-locking between the nut and the thread tube.

3. The electric air pressure rod according to claim 2, wherein an outer wall of the inner tube of the lifting rod is provided with first convex strips evenly distributed along an axis of the outer wall of the inner tube of the lifting rod, wherein an inner wall of the inner tube of the lifting rod is provided with first grooves evenly distributed along an axis of the inner wall of the inner tube of the lifting rod, wherein a second convex strip is provided on an outer wall of the nut, wherein the second convex strip is adapted to the first groove, wherein
a second guide sleeve is provided between the outer tube of the lifting rod as well as the inner tube of the lifting rod, wherein the second guide sleeve is firmly connected to the outer tube of the lifting rod, and wherein a second groove is provided on an inner wall of the second guide sleeve, wherein the second groove is adapted to the second convex strip.

4. The electric air pressure rod according to claim 1, wherein the driving unit comprises a motor, a gear box and a controller, and wherein an output end of the motor drives the thread tube for the rotation through the gear box.

5. The electric air pressure rod according to claim 3, wherein the end of the inner tube of the lifting rod is connected to an inner tube plug of the lifting rod, wherein the inner tube plug of the lifting rod is connected to an end of the piston rod, wherein a side wall of the inner tube plug of the lifting rod is firmly connected to the inner wall of the inner tube of the lifting rod.

6. The electric air pressure rod according to claim 5, wherein a third convex strip is provided on the side wall of the inner tube plug of the lifting rod, wherein the third convex strip is adapted to the first groove.

7. The electric air pressure rod according to claim 6, wherein an end of the casing tube is firmly provided with a sealing plate, wherein an end of the inner tube plug of the lifting rod penetrates the sealing plate and is connected to the sealing plate through a retaining spring.

8. The electric air pressure rod according to claim 1, wherein the seal guide assembly comprises a spacer sleeve, an oil seal and a rear upper sleeve, wherein the oil seal is located between the spacer sleeve and the rear upper sleeve, and wherein the rear upper sleeve is fixedly connected to an end of the thread tube.

9. The electric air pressure rod according to claim 8, wherein a connecting end of the casing tube and a connecting end of the outer tube of the lifting rod both have a shape of truncated cone.

10. The electric air pressure rod according to claim 2, wherein the seal guide assembly comprises a spacer sleeve, an oil seal and a rear upper sleeve, wherein the oil seal is located between the spacer sleeve and the rear upper sleeve, and wherein the rear upper sleeve is fixedly connected to an end of the thread tube.

11. The electric air pressure rod according to claim 3, wherein the seal guide assembly comprises a spacer sleeve, an oil seal and a rear upper sleeve, wherein the oil seal is located between the spacer sleeve and the rear upper sleeve, and wherein the rear upper sleeve is fixedly connected to an end of the thread tube.

12. The electric air pressure rod according to claim 4, wherein the seal guide assembly comprises a spacer sleeve, an oil seal and a rear upper sleeve, wherein the oil seal is located between the spacer sleeve and the rear upper sleeve, and wherein the rear upper sleeve is fixedly connected to an end of the thread tube.

13. The electric air pressure rod according to claim 5, wherein the seal guide assembly comprises a spacer sleeve, an oil seal and a rear upper sleeve, wherein the oil seal is located between the spacer sleeve and the rear upper sleeve, and wherein the rear upper sleeve is fixedly connected to an end of the thread tube.

14. The electric air pressure rod according to claim 6, wherein the seal guide assembly comprises a spacer sleeve, an oil seal and a rear upper sleeve, wherein the oil seal is located between the spacer sleeve and the rear upper sleeve, and wherein the rear upper sleeve is fixedly connected to an end of the thread tube.

15. The electric air pressure rod according to claim 7, wherein the seal guide assembly comprises a spacer sleeve, an oil seal and a rear upper sleeve, wherein the oil seal is located between the spacer sleeve and the rear upper sleeve, and wherein the rear upper sleeve is fixedly connected to an end of the thread tube.

16. The electric air pressure rod according to claim 10, wherein a connecting end of the casing tube and a connecting end of the outer tube of the lifting rod both have a shape of truncated cone.

17. The electric air pressure rod according to claim 11, wherein a connecting end of the casing tube and a connecting end of the outer tube of the lifting rod both have a shape of truncated cone.

18. The electric air pressure rod according to claim 12, wherein a connecting end of the casing tube and a connecting end of the outer tube of the lifting rod both have a shape of truncated cone.

19. The electric air pressure rod according to claim 13, wherein a connecting end of the casing tube and a connecting end of the outer tube of the lifting rod both have a shape of truncated cone.

20. The electric air pressure rod according to claim 14, wherein a connecting end of the casing tube and a connecting end of the outer tube of the lifting rod both have a shape of truncated cone.
